(19) United States
(12) Patent Application Publication
(10) Pub. No.: US 2006/0121156 A1
(43) Pub. Date: Jun. 8, 2006

(54) Degradable chewing gum polymer

(76) Inventors: Lone Andersen, Middelfart (DK); Helle Wittorff, Vejle Ost (DK); Ganesh S. Desai, Hattiesburg, MS (US); Robson Storey, Hattiesburg, MS (US)

Correspondence Address: CANTOR COLBURN, LLP, 55 GRIFFIN ROAD SOUTH, BLOOMFIELD, CT, 06002, US

(21) Appl. No.: 10/528,930

(22) PCT Filed: Sep. 24, 2002
(86) PCT No.: PCT/DK02/00628

§ 371 Date: Sep. 6, 2005

(51) Int. Cl. A23G 4/00

(52) U.S. Cl. 426/3

(57) ABSTRACT

The invention relates to degradable chewing gum polymer, said degradable polymer is a polymer polymerized from at least one trifunctional or higher functional initiator, at least two different monomers forming the backbone of the polymer and at least one monomer selected from the group of carbonate monomers. According to the invention it has been realized that a certain degree of branching of the backbone is needed to obtain a final improved performance, when the polymer, preferably the elastomer, is incorporated in a chewing gum. It has moreover been realized that the obtained degree of branching needs and may actually be carefully controlled in order to avoid too much branching-induced crosslinking.

### FIELD OF THE INVENTION

The present invention relates to a degradable chewing gum polymer according to claim 1.

### BACKGROUND OF THE INVENTION

U.S. Pat. No. 5,672,367 discloses a biodegradable elastomer for chewing gum. The elastomers are generally defined as biodegradable polyester polymers obtained by the polymerization of one or more cyclic esters. Two specific examples are described.

Example 1 describes an amorphous, non-crystallizable copolymer of a polymer of 80 mol % L-lactide and 20 mol % D-lactide that was prepared by ring-opening polymerization in the melt, in the presence of 0.1% by weight tin octoate as a catalyst. To this polymer was added an amount of 20% by weight of epsilon-caprolactone, and subsequently the mixture was heated to 150° C. To the homogeneous mixture, again 0.1% by weight tin octoate as catalyst was added and then the polymerization was completed. The obtained polymer had a glass transition temperature (DSC, heating rate 10° C./min) of 15° C.

Example 3 describes an amorphous, non-crystallizable copolymer of 25 mol % L-lactide, 25 mol % D-lactide and 50 mol % epsilon-caprolactone that was prepared by ring-opening polymerization in the melt, in the presence of 0.1% by weight tin octoate as catalyst. The obtained polymer has a glass transition temperature (DSC, heating rate 10° C./min) of −10° C.

Both exemplified polymers is stated to feature a chew feel strongly resembling that of conventional chewing gum.

However, a disadvantage of the above mentioned polymers is that the properties of the provided polymers differ from conventional chewing gum elastomers for example with respect to the texture of the polymers itself and especially when incorporated in conventional chewing gum formulations.

WO 01/47368 discloses a chewing gum comprising a degradable copolymer obtained by polymerization of two different monomers, one first monomer which is polymerizable by condensation polymerization and one monomer functional to suppress the crystallinity of the copolymer. A problem of the disclosed copolymer is however for example that the elastomeric properties of the resulting copolymer differ when compared to properties of conventional chewing gum. Consequently, it appears very difficult to obtain a completely biodegradable chewing gum based on the disclosed copolymer illustrated by the fact that the examples only disclose partly biodegradable chewing gum.

It is an object of the invention to provide a chewing gum polymer having properties comparable to those of conventional chewing gum elastomers both with respect to the polymer itself and with respect to the interaction with the chewing gum ingredients when incorporated in a chewing gum formulation.

### SUMMARY OF THE INVENTION

The invention relates to a degradable chewing gum polymer, said degradable polymer being a polymer polymerized from

at least one trifunctional or higher functional initiator

at least two different monomers forming the backbone of the polymer and

at least one monomer selected from the group of carbonate monomers.

According to the invention, the obtained polymer has elastomeric properties suitable for chewing gum.

According to the invention, a polymer structure being very suitable as chewing polymer/elastomer has been obtained.

According to the invention it has been realized that a certain degree of branching of the backbone is needed to obtain a final improved performance, when the polymer, preferably the elastomer, is incorporated in a chewing gum. It has moreover been realized that the obtained branching needs to be carefully controlled in order to avoid too much branching-induced crosslinking.

According to the invention, it has surprisingly been realized that this balance between branching/cross-linking may be controlled by a suitable pairing of initiator and carbonate monomer. Such pairing includes among the most significant “control knobs” the mutual concentration of the initiator versus the carbonate monomer.

Moreover, the mutual concentration may be modified under consideration of the structure of the initiator. The higher functional initiator, the lower concentration of the carbonate monomer.

According to the invention, the term hyperbranched preferably indicates that the branching structure is dendritic rather than comb-like. That is, branches extend from other branches, like a tree, rather than many simple branches extending from a well-defined backbone segment (comb-like branching). Hence, hyperbranching may be understood as “branching of a dendritic nature.” Branching in this system is an intermediate stage leading to crossslinking. The molecules first become branched, and then when a branch from one molecule reacts with a branch of another molecule, a crosslink is formed. At intermediate stages within this process, branched and crosslinked molecules coexist. The man of ordinary skill in the art will understand branching and crosslinking and the difference between dendritic and comb-like branching. A good description of dendritic branching compared to other types of branching can be found in the following textbook:

Odian, G. “Principles of Polymerization,” 3rd Ed., Wiley-Interscience, New York, N.Y. (1991); p. 17.

Preferably said at least two different monomers are cyclic.

In an embodiment of the invention the at least two different monomers forming the backbone of the polymer comprise at least one backbone monomer and a at least one backbone comonomer.

In an embodiment of the invention the at least one backbone comonomer imparts disorder in the backbone monomer chain.

According to the invention, it has been realized that the backbone chain comprises at least two different monomers.

In an embodiment of the invention the at least one backbone comonomer is effective to introduce amorpheus regions in the backbone monomer chain.

In an embodiment of the invention the at least two different monomers forming the backbone of the polymer are selected from the group of lactone monomers.

In an embodiment of the invention the lactone monomers are chosen from the group of ε-caprolactone, δ-valerolactone, γ-butyrolactone, and β-propiolactone. It also includes ε-caprolactones, δ-valerolactones, γ-butyrolactones, or β-propiolactones that have been substituted with one or more alkyl or aryl substituents at any non-carbonyl carbon atoms along the ring, including compounds in which two substituents are contained on the same carbon atom.

Examples of the lactones described above are, but not limited to, -caprolactone, t-butyl caprolactone, zeta-enantholactone, deltavalerolactones, the monoalkyl-deltavalerolactones, e.g. the monomethyl-, monoethyl-, monohexyl-deltavalerolactones, and the like; the nonalkyl, dialkyl, and trialkyl-epsilon-caprolactones, e.g. the monomethyl-, monoethyl-, monohexyl-, dimethyl-, di-n-propyl-, di-nhexyl-, trimethyl-, triethyl-, tri-n-epsilon-caprolactones, 5-nonyloxepan-2-one, 4,4,6- or 4,6,6-trimethyl-oxepan-2-one, 5-hydroxymethyloxepan-2-one, and the like; beta-lactones, e. g., beta-propiolactone, beta-butyrolactone gamma-lactones, e. g., gammabutyrolactone or pivalolactone, dilactones, e. g. lactide, dilactides, glycolides, e. g., tetramethyl glycolides, and the like, ketodioxanones, e. g. 1,4-dioxan-2one, 1,5-dioxepan-2-one, and the like. The lactones can consist of the optically pure isomers or two or more optically different isomers or can consist of mixtures of isomers.

In an embodiment of the invention the at least one backbone monomer comprises ε-caprolactone

According to a preferred embodiment of the invention ε-caprolactone is chosen as the main monomer of the backbone, thereby ensuring that the main component of the backbone features a sufficiently low Tg.

In an embodiment of the invention the at least one backbone monomer has a Tg below −40° C., preferably less than −50° C.

In an embodiment of the invention the at least one backbone comonomer comprises δ-valerolactone.

According to a preferred embodiment of the invention δ-valerolactone forms a suitable backbone comonomer. Moreover, it has been realized that the requirements with respect to a low Tg may be somewhat relaxed, when compared to the constraints on the main backbone monomer.

Evidently, it should be noted that the Tg of the comonomer or comonomers becomes more significant with increasing concentration.

In an embodiment of the invention said degradable polymer is polymerized by metal catalyzed ring-opening.

Preferably the carbonate monomer is selected from the group of trimethylene carbonate, 5-alkyl-1,3-dioxan-2-one, 5,5-dialkyl-1,3-dioxan-2-one, or 5-alkyl-5-alkyloxycarbonyl-1,3-dioxan-2-one.

Examples of suitable cyclic carbonates are ethylene carbonate, 3-ethyl-3-hydroxymethyl trimethylene carbonate, propylene carbonate, trimethylene carbonate, trimethylolpropane monocarbonate, 4,6dimethyl-1,3-propylene carbonate, 2,2-dimethyl trimethylene carbonate, and 1,3-dioxepan-2-one and mixtures thereof.

According to the invention several different carboner monomers may be applied. The preferred carbonate monomer is trimethylene carbonate (TMC).

In an embodiment of the invention the at least one monomer selected from the group of carbonate monomers provides a means for introducing additional branching and/or crosslinking to the elastomeric polymer during ring-opening polymerization.

According to the invention cyclic carbonate in the monomer mixture yields precise control over the degree of branching and crosslinking in the final polymer. The mechanism by which the cyclic carbonate monomer imparts crosslinking is based upon the known tendency for metal catalysts, of which stannous octoate is a non-limiting example, to promote transesterification and transcarbonation reactions (intermolecular chain transfer to polymer) during polymerization.

In an embodiment of the invention said at least one polyol comprises a trifunctional or higher functional initiator.

According to the invention, the interaction between the polyol initiator and the carbonate monomer provides the desired branching of the resulting biodegradable polymer.

Another aspect of the present invention is directed to the production of star polymers.

Examples of advantageous multifunctional initiators are, but not limited to glycerol, trimethylolpropane, pentaerythritol, dipentaerythritol, ethoxylated or propoxylated polyamines and other molecules with multiple hydroxyl or other reactive groups and other molecules with multiple hydroxyl or other reactive groups and mixtures thereof.

According to a preferred embodiment of the invention, the preferred initiators are trimethylolpropane and pentaerythritol.

In an embodiment of the invention the degradable chewing gum polymer is polymerized from:

about 20 to 80 wt % of the at least one backbone monomer,

about 19.5 to 79.5 wt % of the at least one backbone comonomer,

about 0.5 to 25 wt % of the at least one monomer selected from the group of carbonate monomers.

In an embodiment of the invention the degradable chewing gum polymer is moreover polymerized from:

About 0.01 to 1.0 wt % of the at least one initiator

In an embodiment of the invention the chewing gum properties of the polymer are adjusted by selection of a suitable order of the multifunctional initiator.

The more functional initiator, the less carbonate for the purpose of generating the desired amount of hyperbranching and crosslinking.

In an embodiment of the invention the rheological properties of the degradable polymer are controlled by adjusting the functional number of initiators.

Moreover, it has been realized that an increase in the functionality of the initiator results in an improved texture and/or improved release of chewing gum ingredients when the polymer is incorporated in a chewing gum.

The molecular weight of lactone monomerer must be within the range of 50-16000 g/mol preferably within the range of 100-3000 g/mol

The molecular weight of carbonate monomerer must be within the range 50-15000 g/mol preferably within the range of 100-2300 g/mol.

In an embodiment of the invention said chewing gum ingredients comprise flavoring agents.

In an embodiment of the invention said flavoring agents comprise natural and synthetic flavourings in the form of natural vegetable components, essential oils, essences, extracts, powders, including acids and other substances capable of affecting the taste profile

In an embodiment of the invention said chewing gum comprises flavor in an amount of 0.01 to about 30 wt %, said percentage being based on the total weight of the chewing gum

In an embodiment of the invention said chewing gum comprises flavor in an amount of 0.2 to about 4 wt %, said percentage being based on the total weight of the chewing gum

In an embodiment of the invention said flavor comprises water soluble ingredients.

In an embodiment of the invention said water soluble flavor comprises acids.

According to the invention, a surprising initial release of acids has been obtained.

In an embodiment of the invention said flavor comprising water insoluble ingredients.

In an embodiment of the invention, said chewing gum ingredients comprising sweeteners.

In an embodiment of the invention said sweetener comprises bulk sweeteners In an embodiment of the invention the chewing gum comprises bulk sweeteners in an amount of about 5 to about 95% by weight of the chewing gum, more typically about 20 to about 80% by weight of the chewing gum.

In an embodiment of the invention the sweetener comprises high intensity sweeteners

In an embodiment of the invention the high intensity sweeteners comprises sucralose, aspartame, salts of acesulfame, alitame, saccharin and its salts, cyclamic acid and its salts, glycyrrhizin, dihydrochalcones, thaumatin, monellin, sterioside, alone or in combination

In an embodiment of the invention wherein the chewing gum comprises high intensity sweeteners in an amount of about 0 to about 1% by weight of the chewing gum, more typically about 0.05 to about 0.5% by weight of the chewing gum.

In an embodiment of the invention, the chewing gum comprises at least one softener.

In an embodiment of the invention, the at least one softener comprises tallow, hydrogenated tallow, hydrogenated and partially hydrogenated vegetable oils, cocoa butter, glycerol monostearate, glycerol triacetate, lecithin, different waxes, mono-, di- and triglycerides, acetylated monoglycerides, fatty acids—such as stearic, palmitic, oleic and linoleic acids mixtures thereof.

In an embodiment of the invention the chewing gum comprises softeners in an amount of about 0 to about 18% by weight of the chewing gum, more typically about 0 to about 12% by weight of the chewing gum.

In an embodiment of the invention, the chewing gum ingredients comprise active ingredients.

In an embodiment of the invention, said active ingredients are selected from the group of: Acetaminophen, Acetylsalicylsyre Buprenorphine Bromhexin Celcoxib Codeine, Diphenhydramin, Diclofenac, Etoricoxib, Ibuprofen, Indometacin, Ketoprofen, Lumiracoxib, Morphine, Naproxen, Oxycodon, Parecoxib, Piroxicam, Pseudoefedrin, Rofecoxib, Tenoxicam, Tramadol, Valdecoxib, Calciumcarbonat, Magaldrate, Disulfiram, Bupropion, Nicotine, Azithromycin, Clarithromycin, Clotrimazole, Erythromycin, Tetracycline, Granisetron, Ondansetron, Prometazin, Tropisetron, Brompheniramine, Ceterizin, leco-Ceterizin, Chlorcyclizine, Chlorpheniramin, Chlorpheniramin, Difenhydramine, Doxylamine, Fenofenadin, Guaifenesin, Loratidin, des-Loratidin, Phenyltoloxamine, Promnethazin, Pyridamine, Terfenadin, Troxerutin, Methyldopa, Methylphenidate, Benzalcon. Chloride, Benzeth. Chloride, Cetylpyrid. Chloride, Chlorhexidine, Ecabet-sodium, Haloperidol, Allopurinol, Colchinine, Theophylline, Propanolol, Prednisolone, Prednisone, Fluoride, Urea, Miconazole, Actot, Glibenclamide, Glipizide, Metformin, Miglitol, Repaglinide, Rosiglitazone, Apomorfin, Cialis, Sildenafil, Vardenafil, Diphenoxylate, Simethicone, Cimetidine, Famotidine, Ranitidine, Ratinidine, cetrizin, Loratadine, Aspirin, Benzocaine, Dextrometorphan, Ephedrine, Phenylpropanolamine, Pseudoephedrine, Cisapride, Domperidone, Metoclopramide, Acyclovir, Dioctylsulfosucc, Phenolphtalein, Almotriptan, Eletriptan, Ergotamine, Migea, Naratriptan, Rizatriptan, Sumatriptan, Zolmitriptan, Aluminium salts, Calcium salts, Ferro salts, Silver salts, Zinc-salte, Amphotericin B, Chlorhexidine, Miconazole, Triamcinolonacetonid, Melatonine, Phenobarbitol, Caffeine, Benzodiazepiner, Hydroxyzine, Meprobamate, Phenothiazine, Buclizine, Brometazine, Cinnarizine, Cyclizine, Difenhydramine, Dimenhydrinate, Buflomedil, Amphetamine, Caffeine, Ephedrine, Orlistat, Phenylephedrine, Phenylpropanolamin, Pseudoephedrine, Sibutramin, Ketoconazole, Nitroglycerin, Nystatin, Progesterone, Testosterone, Vitamin B12, Vitamin C, Vitamin A, Vitamin D, Vitamin E, Pilocarpin, Aluminiumaminoacetat, Cimetidine, Esomeprazole, Famotidine, Lansoprazole, Magnesiumoxide, Nizatide and or Ratinidine or derivates and mixtures thereof.

In an embodiment of the invention, the chewing gum is substantially free of non-biodegradable polymers

In an embodiment of the invention the at least two ore more cyclic esters are selected from the groups of glycolides, lactides, lactones, cyclic carbonates or mixtures thereof.

In an embodiment of the invention the lactone monomers are chosen from the group of ε-caprolactone, δ-valerolactone, γ-butyrolactone, and β-propiolactone. It also includes ε-caprolactones, δ-valerolactones, γ-butyrolactones, or β-propiolactones that have been substituted with one or more alkyl or aryl substituents at any non-carbonyl carbon atoms along the ring, including compounds in which two substituents are contained on the same carbon atom.

In an embodiment of the invention the carbonate monomer is selected from the group of trimethylene carbonate, 5-alkyl-1,3-dioxan-2-one, 5,5-dialkyl-1,3-dioxan-2-one, or 5-alkyl-5-alkyloxycarbonyl-1,3-dioxan-2-one, ethylene carbonate, 3-ethyl-3-hydroxymethyl, propylene carbonate, trimethylolpropane monocarbonate, 4,6dimethyl-1,3-propylene carbonate, 2,2-dimethyl trimethylene carbonate, and 1,3-dioxepan-2-one and mixtures thereof.

In an embodiment of the invention the cyclic ester polymers and their copolymers resulting from the polymerization of cyclic ester monomers include, but are not limited to: poly (L-lactide); poly (D-lactide); poly (D, L-lactide); poly (mesolactide); poly (glycolide); poly (trimethylenecarbonate); poly (epsilon-caprolactone); poly (L lactide-co-D, L-lactide) poly (L-lactide-co-meso-lactide); poly (L-lactide co-glycolide); poly (L-lactide-co-trimethylenecarbonate); poly (L-lactide co-epsilon-caprolactone); poly (D, L-lactide-co-meso-lactide); poly (D, L lactide-co-glycolide); poly (D, L-lactide-co-trimethylenecarbonate); poly (D, L-lactide-co-epsilon-caprolactone); poly (meso-lactide-co glycolide); poly (meso-lactide-co-trimethylenecarbonate); poly (meso lactide-co-epsilon-caprolactone); poly (glycolide-cotrimethylenecarbonate); poly (glycolide-co-epsilon-caprolactone).

In an embodiment of the invention the chewing gum comprises filler.

A chewing gum base formulation may, if desired, include one or more fillers/texturisers including as examples, magnesium and calcium carbonate, sodium sulphate, ground limestone, silicate compounds such as magnesium and aluminium silicate, kaolin and clay, aluminium oxide, silicium oxide, talc, titanium oxide, mono-, di- and tri-calcium phosphates, cellulose polymers, such as wood, and combinations thereof.

In an embodiment of the invention the chewing gum comprises filler in an amount of about 0 to about 50% by weight of the chewing gum, more typically about 10 to about 40% by weight of the chewing gum.

In an embodiment of the invention the chewing gum comprises at least one coloring agent.

According to an embodiment of the invention, the chewing gum may comprise color agents and whiteners such as FD&C-type dyes and lakes, fruit and vegetable extracts, titanium dioxide and combinations thereof. Further useful chewing gum base components include antioxidants, e.g. butylated hydroxytoluene (BHT), butyl hydroxyanisol (BHA), propylgallate and tocopherols, and preservatives.

In an embodiment of the invention the chewing gum is coated with an outer coating.

In an embodiment of the invention the outer coating is a hard coating.

In an embodiment of the invention the hard coating is a coating selected from the group consisting of a sugar coating and a sugarless coating and a combination thereof.

In an embodiment of the invention the hard coating comprises 50 to 100% by weight of a polyol selected from the group consisting of sorbitol, maltitol, mannitol, xylitol, erythritol, lactitol and isomalt.

In an embodiment of the invention the outer coating is an edible film comprising at least one component selected from the group consisting of an edible film-forming agent and a wax.

In an embodiment of the invention the film-forming agent is selected from the group consisting of a cellulose derivative, a modified starch, a dextrin, gelatine, shellac, gum arabic, zein, a vegetable gum, a synthetic polymer and any combination thereof.

In an embodiment of the invention the outer coating comprises at least one additive component selected from the group consisting of a binding agent, a moisture absorbing component, a film forming agent, a dispersing agent, an antisticking component, a bulking agent, a flavouring agent, a colouring agent, a pharmaceutically or cosmetically active component, a lipid component, a wax component, a sugar, an acid and an agent capable of accelerating the after-chewing degradation of the degradable polymer.

In an embodiment of the invention the outer coating is a soft coating.

In an embodiment of the invention the soft coating comprises a sugar free coating agent.

In an embodiment of the invention the chewing gum comprises conventional chewing gum polymers or resins.

In an embodiment of the invention the at least one biodegradable polymer comprises at least 5% of the chewing gum polymers.

In an embodiment of the invention all the biodegradable polymers comprised in the chewing gum comprises at least 25%, preferably at least 50% of the chewing gum polymers.

In an embodiment of the invention the biodegradable polymers comprised in the chewing gum comprises at least 80%, preferably at least 90% of the chewing gum polymers.

In an embodiment of the invention the chewing gum comprises

said at least one biodegradable polyester copolymer forming a plasticizer of the chewing gum and

at least one non-biodegradable conventional elastomer

According to the invention, a biodegradable polymer according to the invention may form a substitute of a conventional natural or synthetic resin.

In an embodiment of the invention the chewing gum comprises the at least one biodegradable polyester copolymer forming an elastomer of the chewing gum and at least one non-biodegradable conventional natural or synthetic resin.

According to the invention, a biodegradable polymer according to the invention may form a substitute of a conventional low or high molecular weight elastomer.

In an embodiment of the invention said chewing gum comprises
at least one biodegradable elastomer in the amount of about 0.5 to about 70% wt of the chewing gum,
at least one biodegradable plasticizer in the amount of about 0.5 to about 70% wt of the chewing gum and
at least one chewing gum ingredient chosen from the groups of softeners, sweeteners, flavoring agents, active ingredients and fillers in the amount of about 2 to about 80% wt of the chewing gum.

### THE FIGURES

The invention will now be described with reference to the drawings of which

FIG. 1 illustrates a transcarbonation reaction during stannous octoate-catalyzed ring-opening polymerization,

FIG. 2 to 5 and 10 to 12 illustrate different measured texture properties of the obtained biodegradable chewing gum polymer and where

FIG. 6 to 9 illustrate the measured LVR properties of the obtained polymers when incorporated in chewing gum at the chewing times 15, 30, 60 and 120 seconds, respectively.

FIG. 13 to 16 illustrate release properties of the obtained polymers when incorporated in chewing gum.

### DETAILED DESCRIPTION

The following examples of the invention are non-limiting and only provided for the purpose of explaining the invention.

Unless otherwise indicated, as used herein, the term “molecular weight” means number average molecular weight (Mn).

It has surprisingly been found that biodegradable elastomers, suitable for the formulation of chewing gum base, can be made by metal-catalyzed ring-opening polymerization using a combination of an initiator comprising a trifunctional or higher polyol and a mixture of cyclic monomers including lactones and at least one cyclic carbonate monomer. These polymers derive their excellent elastomeric properties from the fact that they are non-crystallizable polymers with a glass transition temperature below room temperature, and they are hyperbranched or lightly crosslinked materials, which characteristic imparts excellent elasticity and recovery.

The various monomers are strategically selected to impart specific properties to the polymers of the invention. The requirement of non-crystallizability is achieved through the use of two or more monomers that can enter the polymer chain in an approximately random sequence, thus imparting disorder along the backbone. Crystallization is also hindered by the branch point introduced by the trifunctional or higher polyol initiator. The monomer representing the major component of the backbone, which should also possess a very low homopolymer glass transition temperature, is selected from the family of aliphatic lactones, with ε-caprolactone being a non-limiting example The comonomer or comonomers used to impart disorder should also be selected from the family of aliphatic lactones, but must be different from the major-component monomer. A representative but non-limiting example of a monomer suitable for use with the major-component monomer is δ-valerolactone.

The critical, and perhaps most surprising discovery of the invention is that the addition of a small proportion of a carbonate monomer, of which 1,3-dioxan-2-one (trimethylene carbonate) is a non-limiting example, provides a means for introducing additional branching and/or crosslinking to the elastomeric polymer during ring-opening polymerization. In fact, the level of cyclic carbonate in the monomer mixture yields precise control over the degree of branching and crosslinking in the final polymer. The mechanism by which the cyclic carbonate monomer imparts crosslinking is based upon the known tendency for metal catalysts, of which stannous octoate is a non-limiting example, to promote transesterification and transcarbonation reactions (intermolecular chain transfer to polymer) during polymerization.

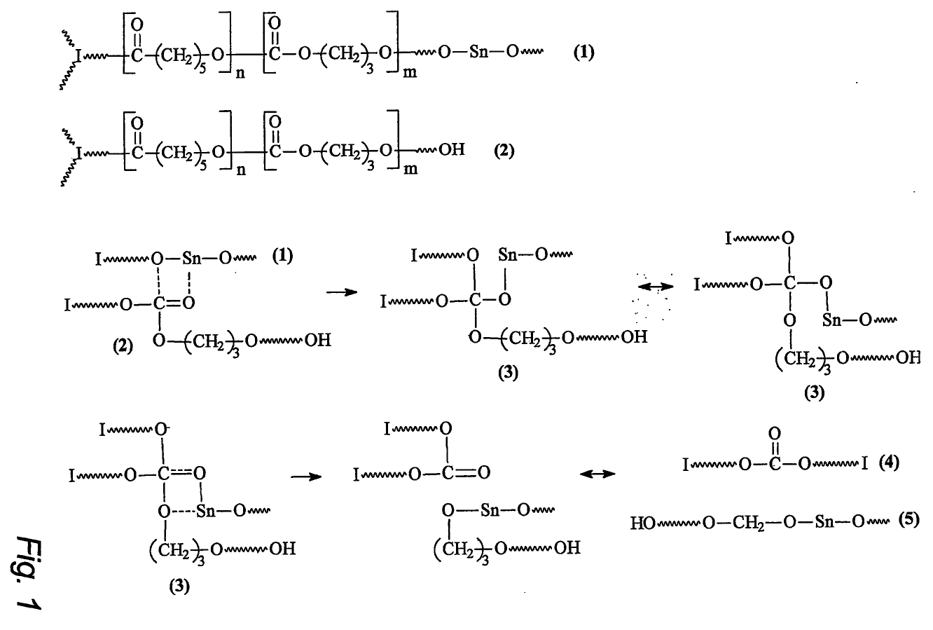

A transcarbonation reaction during stannous octoate-catalyzed ring-opening polymerization of lactone and carbonate monomers is illustrated in the FIG. 1.

This mechanism is shown in the figures. FIG. 1 illustrate three-arm star polymer molecules produced from a trifunctional polyol initiator (I) such as trimethylolpropane. The backbone of these polymers is composed of randomly incorporated ε-caprolactone and trimethylene carbonate mer units, and the ends of each arm carry either a polymerization-active stannyl ether group as illustrated in (1) or a polymerization-inactive hydroxyl group as illustrated in (2). Tranesterification (transcarbonation) involves reaction of the stannyl ether group of one chain with an internal ester (carbonate) linkage of another chain. In (3) a transcarbonation reaction between species illustrated (1) and (2) has been obtained, thereby creating the intermediate (3). The latter can decompose to yield two different products because the carbonate linkage has two different acyl-oxygen bonds that may be broken. The decomposition pathway pictured in the figure illustrated scheme is the one of interest because it yields a new species (4) in which two initiator branch points have become connected. This species represents the very early stages of hyperbranching. As similar reactions take place, more and more branching occurs and the system eventually becomes crosslinked. The degree of crosslinking depends upon the fractional loading of the cyclic carbonate monomer and the polymerization conversion. The alternate decomposition pathway not pictured does not lead to branching and crosslinking. Also, in the absence of a carbonate monomer, branching and crosslinking do not take place.

(5) represents the remaining not-branched copolymer

The trifunctional or higher polyol initiators useful in the present invention include glycerol, trimethylolpropane, pentaerythritol, dipentaerythritol and ethoxylated or propoxylated polyamines. The preferred initiators are trimethylolpropane and pentaerythritol.

The monomer representing the major component of the backbone, and the comonomer or comonomers used to impart disorder may be chosen from the same group. This group includes ε-caprolactone, δ-valerolactone, γ-butyrolactone, and β-propiolactone. It also includes ε-caprolactones, δ-valerolactones, γ-butyrolactones, or β-propiolactones that have been substituted with one or more alkyl or aryl substituents at any non-carbonyl carbon atoms along the ring, including compounds in which two substituents are contained on the same carbon atom. The preferred major component monomer is ε-caprolactone. The preferred comonomer is δ-valerolactone.

The carbonate monomers useful in the present invention include trimethylene carbonate, 5-alkyl-1,3-dioxan-2-one, 5,5-dialkyl-1,3-dioxan-2-one, or 5-alkyl-5-alkyloxycarbonyl-1,3-dioxan-2-one. The preferred carbonate monomer is trimethylene carbonate.

In general, the level of crosslinking and the level of hyperbranching would scale approximately the same, that is, if one were high or low, so would the other one be.

In general the larger is the ratio carbonate monomer/initiator, the higher the level of hyperbranching and crosslinking.

During polymerization at high temperature, a small fraction of the polymer chains contains catalyst as a part of their structure. The catalyst is transferred from chain to chain in a rapid chemical equilibrium. After polymerization, upon cooling and after polymer workup, the catalyst is believed to not be part of the polymer structure.

### EXAMPLE 1

Preparation of Resin

A resin sample was produced using a cylindrical glass, jacketed 10 L pilot reactor equipped with glass stir shaft and Teflon stir blades and bottom outlet. Heating of the reactor contents was accomplished by circulation of silicone oil, thermostated to 130° C., through the outer jacket. D,L-lactide (4.877 kg, 33.84 mol) was charged to the reactor and melted by heating to 140° C. for 6 h. After the D,L-lactide was completely molten, the temperature was reduced to 130° C., and stannous octoate (1.79 g, 4.42×10⁻³ mol), 1,2-propylene glycol (79.87 g, 1.050 mol), and ε-caprolactone (290.76 g, 2.547 mol) were charged to the reactor. After the mixture became homogeneous, stirring was continued for 24 h at 130° C. At the end of this time, the bottom outlet was opened, and molten polymer was allowed to drain into a Teflon-lined paint can.

Characterization of the product indicated Mₙ=5,700 g/mol and M_{w}=7,100 g/mol (gel permeation chromatography with online MALLS detector) and Tg=30.7° C. (DSC, heating rate 10° C./min).

### EXAMPLE 2

Preparation of LMWE Elastomer

A 515 g LMWE sample was synthesized within a dry N₂ glove box, as follows. Into a 500 mL resin kettle equipped with overhead mechanical stirrer, 0.73 g 1,2-propane diol (3.3 mL of a 22.0% (w/v) solution in methylene chloride), and 0.152 g Sn(Oct)₂ (3.56 ml of a 4.27% (w/v) solution in methylene chloride) were charged under dry N₂ gas purge. The methylene chloride was allowed to evaporate under the N₂ purge for 15 min. Then ε-caprolactone (300 g, 2.63 mol) and δ-valerolactone (215 gm, 2.15 mol) were added. The resin kettle was submerged in a 130° C. constant temperature oil bath and stirred for 14 h. Subsequently the kettle was removed from the oil bath and allowed to cool at room temperature. The solid, elastic product was removed in small pieces using a knife, and placed into a plastic container.

Characterization of the product indicated Mₙ=59,900 g/mol and M_{w}=74,200 g/mol (gel permeation chromatography with online MALLS detector) and T_{g}=−70° C. (DSC, heating rate 10° C./min).

### EXAMPLE 3

Preparation of HMWE Made with Difunctional Initiator

A HMWE sample was synthesized within a dry N₂ glove box, as follows. Into a 500 mL resin kettle equipped with overhead mechanical stirrer, 0.51 g 1,2-propane diol (2.3 mL of a 22.0% (w/v) solution in MeCl₂), and 0.15 g Sn(Oct)₂ (2.6 mL of a 5.83% (w/v) solution of in MeCl₂) were charged under dry N₂ gas purge. The MeCl₂ was allowed to evaporate under the N₂ purge for 15 min. Then ε-caprolactone (274 g, 2.40 mol), TMC (49 g, 0.48 mol), and δ-valerolactone (192 g, 1.92 mol) were added. The resin kettle was submerged in a 130° C. constant-temperature oil bath and stirred for 14 h. Subsequently the kettle was removed from the oil bath and allowed to cool to room temperature. The solid, elastic product was removed in small pieces using a knife, and placed into a plastic container.

Characterization of the product indicated Mₙ=72,400 g/mol and M_{w}=103,300 g/mol (gel permeation chromatography with online MALLS detector) and T_{g}=−66° C. (DSC, heating rate 10° C./min).

### EXAMPLE 4

Preparation of HMWE Made with 4-Arms Starshaped Initiator

A HMWE sample according to the invention was synthesized in a dry N₂ glove box, as follows. Into a 500 mL resin kettle equipped with overhead mechanical stirrer was charged 0.037 g Sn(Oct)₂ (3.4 ml of a 1.10% (w/v) solution in methylene chloride) under dry N₂ gas purge. The methylene chloride was allowed to evaporate under the N₂ purge for 15 min. Then, pentaerythritol (0.210 g, 1.54×10⁻³ mol), ε-caprolactone (79.0 g, 0.692 mol), TMC(8.0 g, 0.078 mol) and δ-valerolactone (38.0 g, 0.380 mol) were added. The resin kettle was submerged in a 130° C. constant temperature oil bath and stirred for 14 h. Subsequently the kettle was removed from the oil bath and allowed to cool at room temperature. The solid, elastic product was removed in small pieces using a knife, and placed into a plastic container. Characterization of the product indicated Mₙ=64,600 g/mol and M_{w}=165,200 g/mol (gel permeation chromatography with online MALLS detector) and T_{g}=−66° C. (DSC, heating rate 10° C./min).

### EXAMPLE 5

Preparation of Gumbases

All the gumbases are prepared with following basic formulation:

TABLE 1
Gumbase preparation

| Ingredients | Percent by weight |
|---|---|
| Elastomer HMWE | 20 |
| Elastomer LMWE | 40 |
| Resin | 40 |

| | | Elastomer | | |
|---|---|---|---|---|
| No | Type | HMWE | Elastomer LMWE | Resin |
| 101 | Stan- | Polyisobutylene | Polyisobutylene | Polyvinylacetate |
| | dard | Mn = 73.000 | Mn = 30.000 | Mn = 5000 |
| 102 | 2-arms | Elastomer | Elastomer | Resin polymer |
| | initator | polymer | polymer | from example 1 |
| | | from example 3 | from example 2 | |
| 103 | 4-arms | Elastomer | Elastomer | Resin polymer |
| | initiator | polymer | polymer | from example 1 |
| | | from example 4 | from example 2 | |

The gumbases are prepared as follows:

HMWE elastomer is added to a mixing kettle provided with mixing means like e.g. horizontally placed Z-shaped arms. The kettle had been preheated for 15 minutes to a temperature of about 60-80° C. The rubber is broken into small pieces and softened with mechanical action on the kettle.

The resin is slowly added to the elastomer until the mixture becomes homogeneous. The remaining resin is then added to the ketttle and mized for 10-20 minutes. The LMWE elastomer is added and mixed for 20-40 minutes until the whole mixture becomes homogeneous.

The mixture is then discharged into the pan and allowed to cool to room temperature from the discharged temperature of 60-80° C., or the gumbase mixture is used directly for chewing gum by adding all chewing gum components in an appropriate order under continuous mixing.

### EXAMPLE 6

Preparation of Chewing Gum

All chewing gum formulations are prepared with the following basic formulation

Peppermint:

TABLE 2
Peppermint chewing gum preparation

| Ingredients | Percent by weight |
|---|---|
| Gum base | 40 |
| Sorbitol | 48.6 |
| Lycasin | 3 |
| Peppermint oil | 1.5 |
| Menthol crystals | 0.5 |
| Aspartame | 0.2 |
| Acesulfame | 0.2 |
| Xylitol | 6 |

| | Type | Gumbase |
|---|---|---|
| 1001 | std | 101 |
| 1002 | difunctional initiator | 102 |
| 1003 | 4-arms starshaped initiator | 103 |

Strawberry:

TABLE 3
Strawberry chewing gum preparation

| Ingredients | Percent by weight |
|---|---|
| Gum base | 40 |
| Sorbitol | 46.7 |
| Lycasin | 3 |
| Lecithin | 0.3 |
| Wild Strawberry oil | 2 |
| Apple acid | 0.5 |
| Citric acid | 1.1 |
| Aspartame | 0.3 |
| Acesulfame | 0.1 |
| Xylitol | 6 |

| | Type | Gumbase |
|---|---|---|
| 1004 | Difunctional initiator | 102 |
| 1005 | 4-arms starshaped initiator | 103 |

The chewing gum products are prepared as follows:

The gumbase is added to a mixing kettle provided with mixing means like e.g. horizontally placed Z-shaped arms. The kettle had been preheated for 15 minutes to a temperature of about 60-80° C. Or the chewing gum is one step, immediately after preparation of gumbase in the same mixer where the gum base and kettle have a temperature of about 60-80° C.

MINT FORMULATION:

One third portion of the sorbitol is added together with the gum base and mixed for 1-2 minutes. Another one third portion of the sorbitol and lycasin is then added to the kettle and mixed for 2 minutes. The remaining one third portion of sorbitol, peppermint and menthol are added and mixed for 2 minutes. Then aspartame and acesulfame are added to the kettle and mixed for 3 minutes. Xylitol is added and mixed for 3 minutes. The resulting gum mixture is then discharged and e.g. transfered to a pan at temperature of 40-48° C. The gum is then rolled and scored into cores, sticks, balls, cubes, and nay other desired shape, optionally followed by coating and polishing processes prior to packaging.

STRAWBERRY FORMULATION:

One third portion of the sorbitol is added together with the gum base and mixed for 1-2 minutes. Another one third portion of the sorbitol, lycasin and lecithin are then added to the kettle and mixed for 2 minutes. The remaining one third portion of sorbitol, strawberry and acids are added and mixed for 2 minutes. Then aspartame and acesulfame are added to the kettle and mixed for 3 minutes. Xylitol is added and mixed for 3 minutes. The resulting gum mixture is then discharged and e.g. transffered to a pan at temperature of 40-48° C. The gum is then rolled and scored into cores, sticks, balls, cubes, and any other desired shape, optionally followed by coating and polishing processes prior to packaging.

### EXAMPLE 7

An experiment was set up in order to test if the 4-arms starshaped HMWE elastomer has a closer reological match, to conventional HMWE elastomer e.g. polyisobutylene or butylrubber, compared with a HMWE elastomer made with a difunctional initiator.

Accordingly, the following Theological parameters were measured using a rheometer, type AR1000 from TA Instruments. The oscillation measurement is performed at a stress within the linear viscoelastic region and a temperature of 130° C. with a parallel plate system (d=2.0 cm, hatched). G′, and tan delta vs. shear rate.

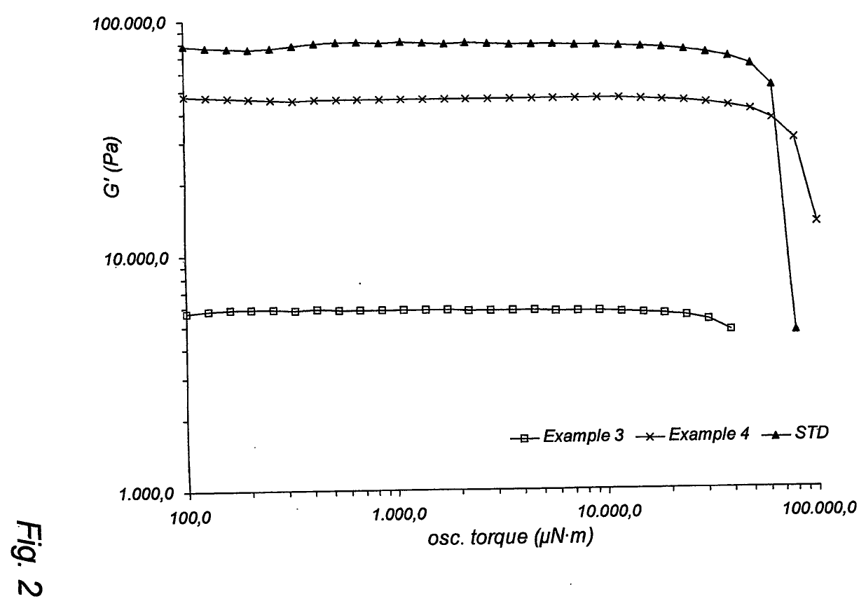

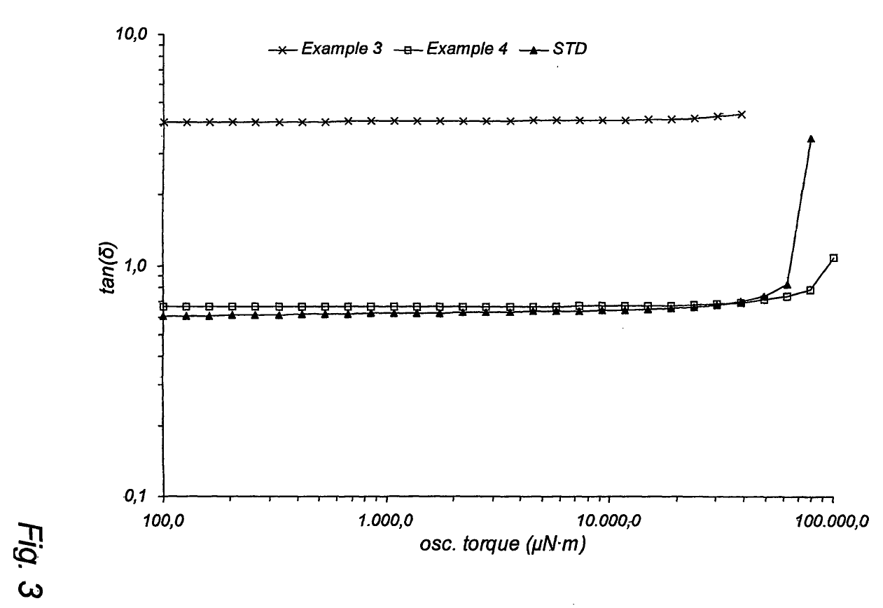

The results are summarised in FIGS. 2, 3 and as it appears, the elasticity of the elastomer made with 4-arms star shaped initiator was much closer to the conventional elastomer than the elastomer with a difunctional initiator. The same appears when looking at storage modulus G′.

### EXAMPLE 8

An experiment was set up in order to test gumbases, prepared according to EXAMPLE 5, containing the same elastomers decribed in EXAMPLE 7.

Thus, a standard gum base containing 20% HMWE PIB (sample 101, table 1) was compared with a gum base containing 20% HMWE elastomer made with difunctional initiator (sample 102, table 1) and a gum base containing 20% HMWE elastomer made with 4-arms star shaped initiator (sample 103, table 1). Accordingly, the following Theological parameters G′ and tan delta vs. shear rate at 130° C. were measured using the method and rheometer described in the previous example.

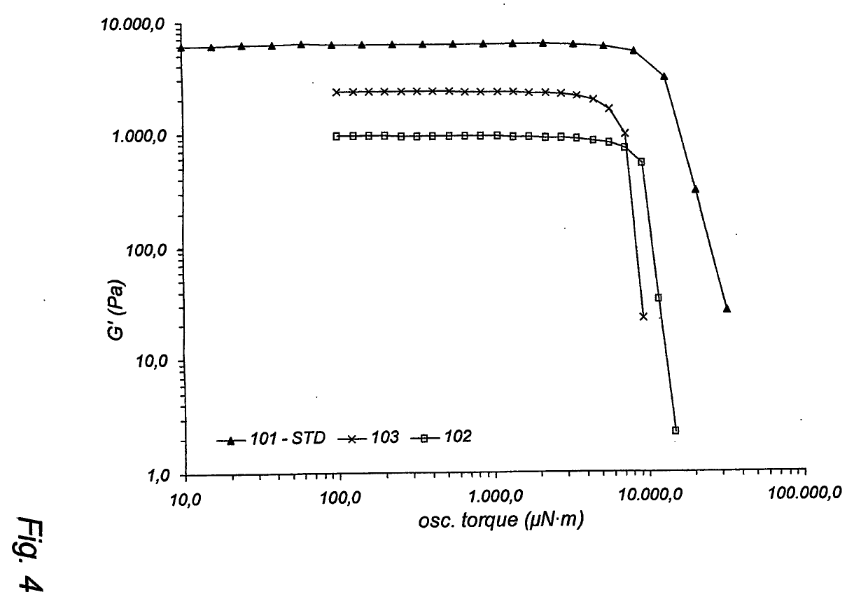

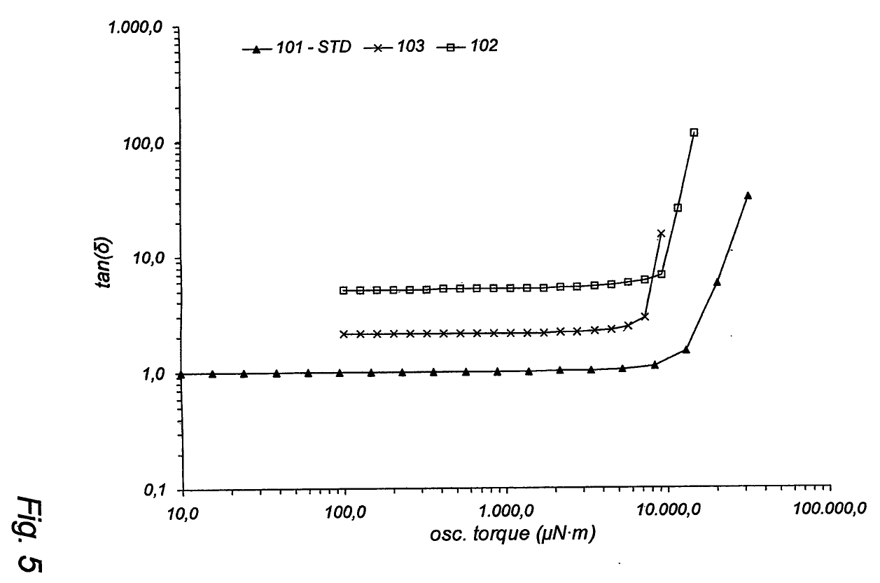

The results are summarised in FIGS. 4 and 5 and as it appears, the gumbase containing the star-shaped elastomer (103) gives a closer Theological match to the gumbase containing conventional elastomers (101) compared to gumbase containing elastomer made with a diol initiator (102).

### EXAMPLE 9

Chewing Profile

An experiment was set up in order to test the corresponding chewing gum samples to the gum bases described in EXAMPLE 8. Prepared as described in EXAMPLE 6.

In order to test the chewing profile of the chewing gum samples containing the gum bases with star shaped biodegradable elastomer, difunctional elastomer and std (samples 1003, 1002 and 1001, respectively). The gum centres were chewed in a chewing machine (CF Jansson). The chewing frequency was set to 1 Hz, a pH buffer was used as saliva and the temperature was set at 37° C. The chewing time was set to 15 seconds, 30 seconds, 60 seconds and 120 seconds. After chewing, the chewed cud was measured on a rheometer, described in EXAMPLE 7 as oscillation measurements at a temperature of 37° C.

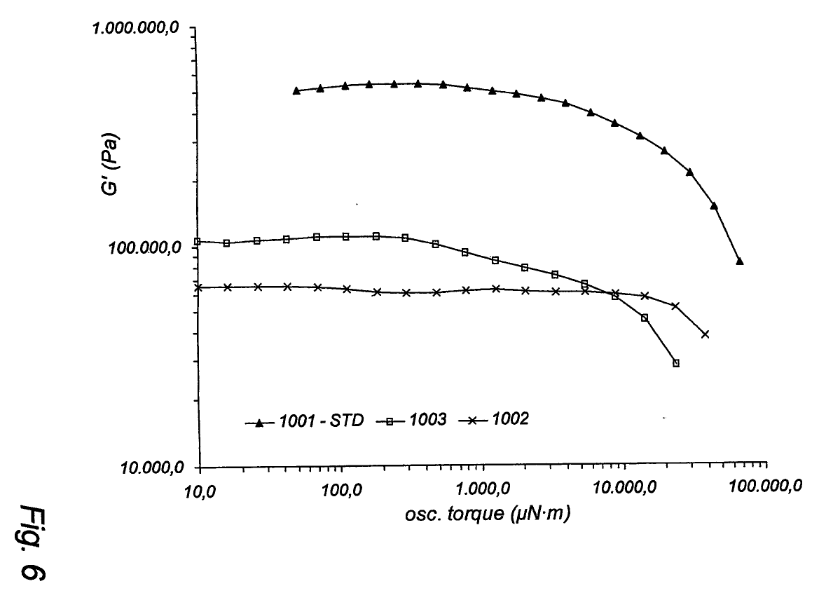

The results from these measurements can be seen on FIGS. 6, 7, 8 and 9 wherein the storage modulus (G′) versus oscillation torque is depicted at different chewing times illustrating the texture changes during chewing.

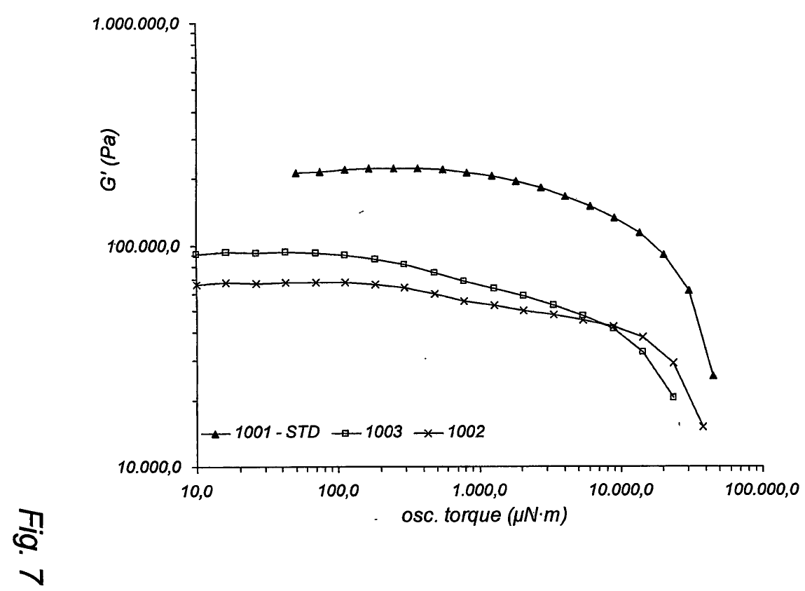

From FIG. 6 it can be seen that while the two chewing gum formulations containing elastomers made from difunctional star shaped initiator (1002) and from multi star shaped initiator (1003) are somewhat softer in the initial phase, after 30 seconds, see FIG. 7, the standard (1001) is getting closer to the two others and the sample 1003 is now closer to standard compared with 1002.

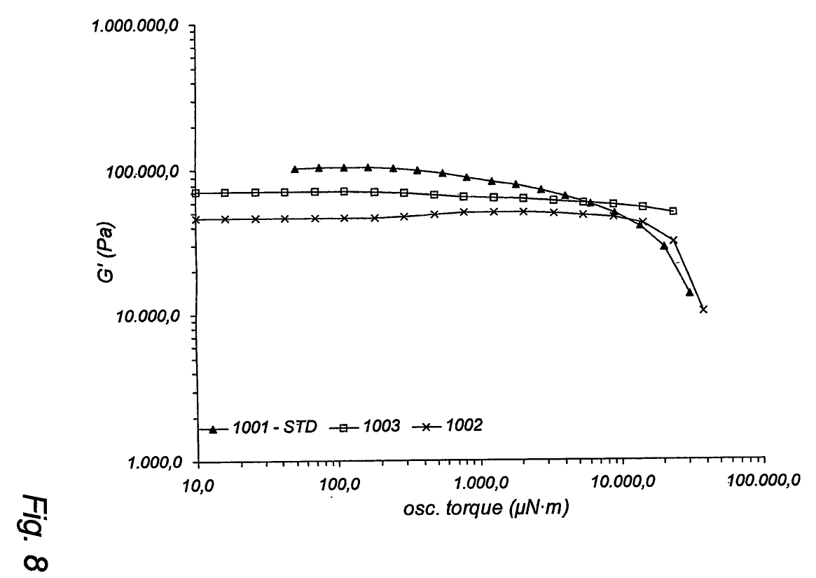

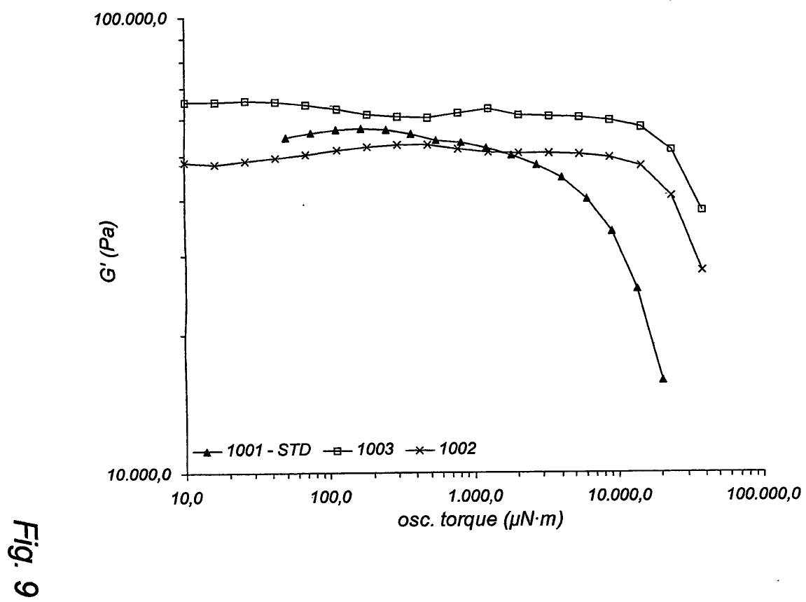

As illustrated in FIG. 8 the difference between the three samples is similar to the difference illustrated in FIG. 7 after 60 seconds. After 120 seconds, see FIG. 9, the difference is smaller, and the values measured on sample 1003 are still closest to the standard formulation 1003.

The above rheological results are confirming the fact that the elastomer made with 4-arms star shaped initiator has texture properties closer to conventional elastomers as compared to elastomer made with difunctional initiator, also as a function of time.

### EXAMPLE 10

Sensory Texture Profile Analyses of Test Chewing Gum

The three chewing gum samples were tested by serving them to the sensory panellists in tasting booths made in accordance with ISO 8598 standards at room temperature in 40 ml tasteless plastic cups with randomised 3-figure codes. Test samples were evaluated after chewing for 0-½ minutes (initial phase 1), ½-1 minutes (initial phase 2), 1-1½ minutes (intermediate 1), 1½-2 minutes (intermediate 2), 2-2½ minutes (intermediate 3), 2½-3 minutes (intermediate 4),4-4½ minutes (end phase 1), 4½-5 minutes (end phase 2), respectively. Between each sample tested, the panellist were allowed a break of 3 minutes. Every test is repeated.

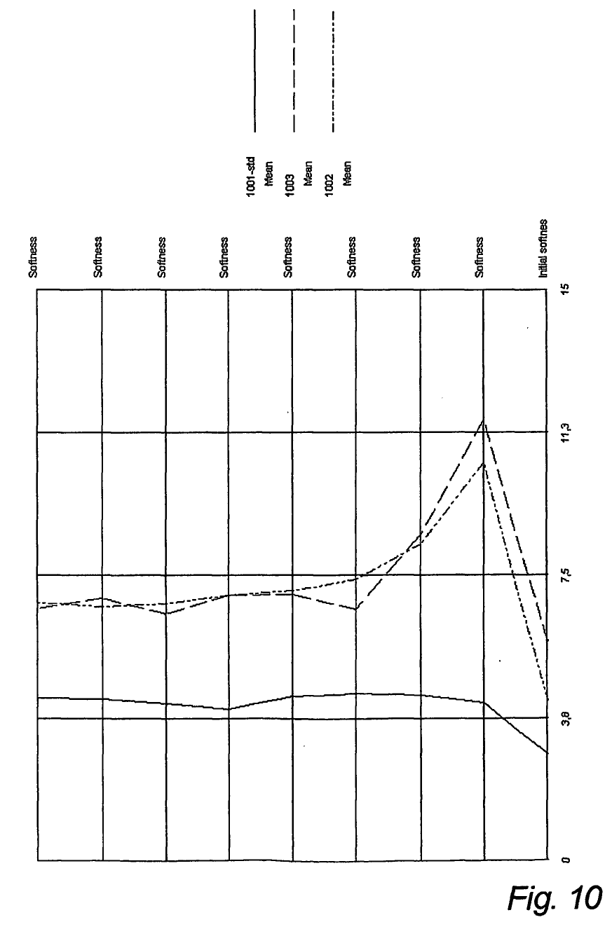

The following texture parameters were assessed: softness, toughness and elasticity. For each of these parameters, the panellists were required to provide their assessments according to an arbitrary scale of 0-15. The data obtained were processed using a FIZZ computer program (French Bio System) and the results were transformed to sensory profile diagrams as shown in FIG. 10-12. The major differences between test chewing gums in all phases were the following:

The chewing gum containing initiator made elastomers (1002, 1003) showed a higher softness compared with standard (confirming the rheological results in the above EXAMPLE 9). When comparing the chewing gum containing initiator made polymers 1002 and 1003, the softness of 1003 (star-shaped) is closer to standard excect for the initial phases.

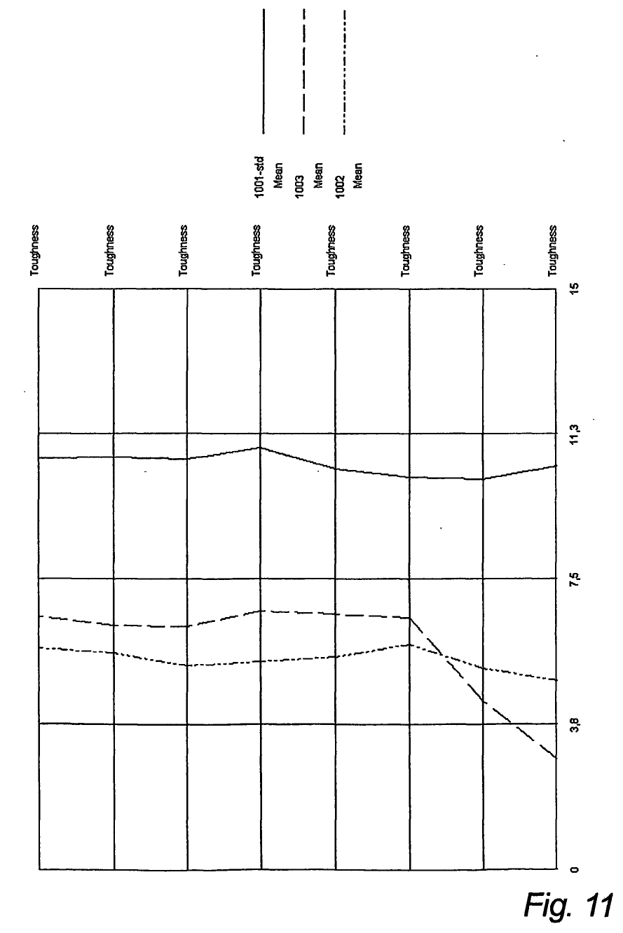

FIG. 11 showed a higher toughness of the chewing gum containing elastomer made with 4-arms star shaped initiator (1003) compared with difunctional initiator made elastomer (1002) excect for the initials phases. The toughness of 1003 is closer to standard compared with 1002.

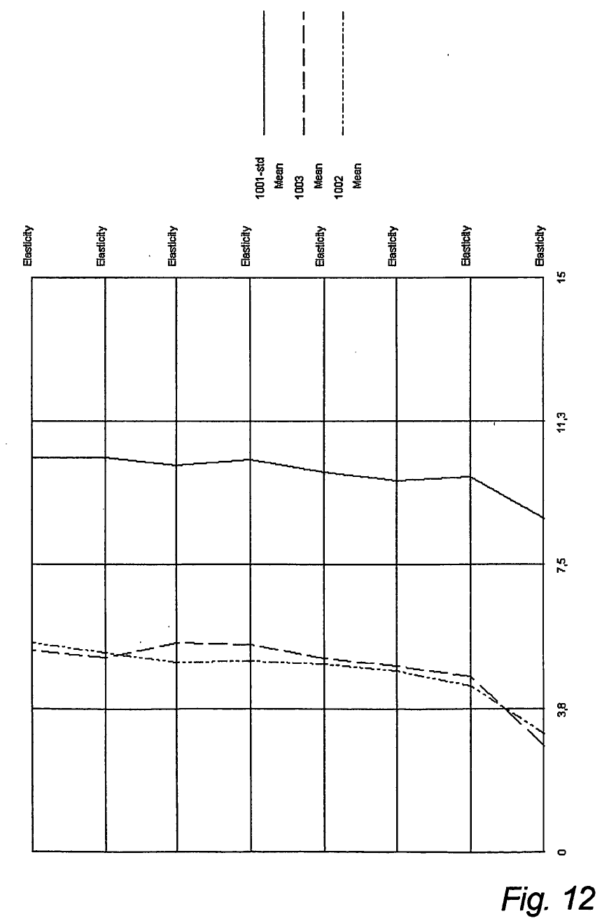

The elastisity of 4-arms star shaped elastomer is expected to be higher due to the branching, which is confirmed by FIG. 12. Where 1003 was found higher in elasticity and closer to the standard compared with 1002 (made with difunctional initiator) in about 70% of the time tested.

### EXAMPLE 11

Sensory Flavour Profile Analyses of Test Chewing Gum

The three chewing gum samples were tested using the sensory method described in the above EXAMPLE 10.

Test samples were evaluated after chewing for 0-1 minutes (initial phase 1), 1-2 minutes (intermediate phase 1), 2-3 minutes (intermediate phase 2), 3-4 minutes (intermediate 3), 4-5 minutes (end phase 1), respectively.

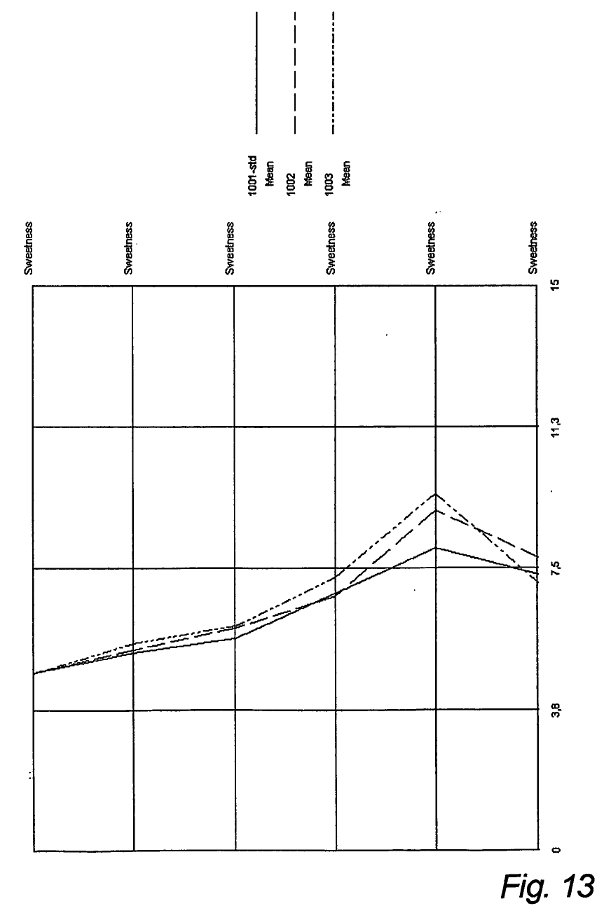

The following flavour parameters were assessed: sweetness, flavour intensity and cooling. For each of these parameters, the panellists were required to provide their assessments according to an arbitrary scale of 0-15. The data obtained were processed using a FIZZ computer program (French Bio System) and the results were transformed to sensory profile diagrams as shown in FIG. 13-15.

The major differences between the chewing gums in all phases were the following:

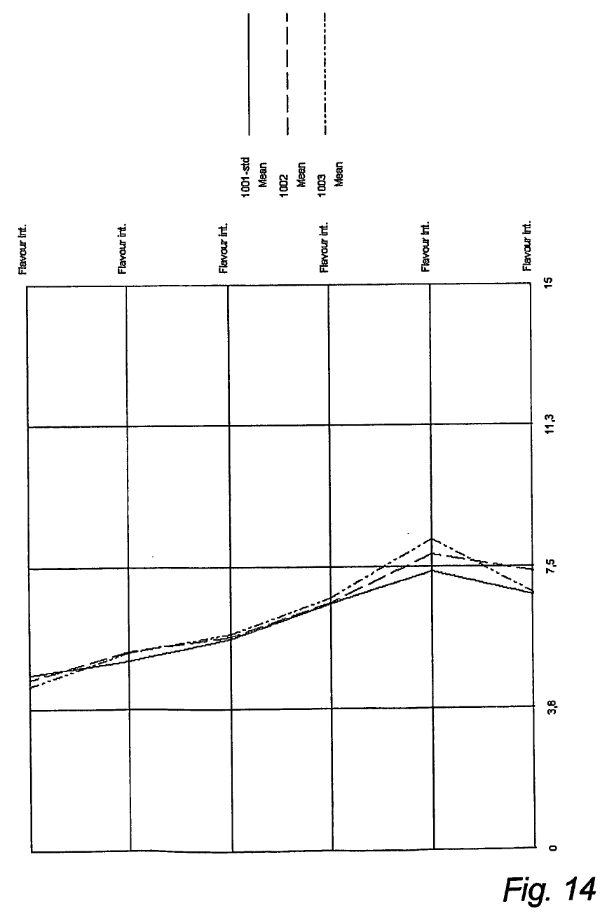

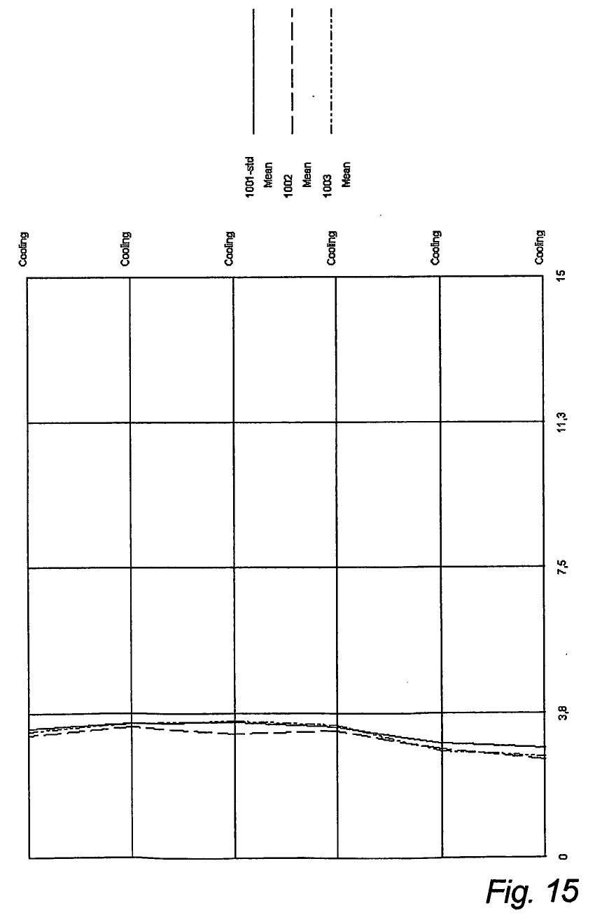

The chewing gum containing elastomer made with 4-arms star shaped initiator 1003 showed higher sweetness release for the inital phase (FIG. 13). Cooling and overall flavour intensity were found higher in release compared to the chewing gum formulation containing HMWE elastomer made with a difunctional initiator 1002 (FIG. 14 and 15).

It can therefore be concluded that the use of a 4-arms star shaped initiator is superior with regard to essential flavour characteristics.

### EXAMPLE 12

Sensory Time Intensity Analysis of Test Chewing Gum

Two strawberry chewing gum samples were tested by serving them to the sensory panellists in tasting booths made in accordance with ISO 8598 standards at room temperature in 40 ml tasteless plastic cups with randomised 3-figure codes. Samples were tested during 3 minutes and evaluated every 10 seconds. Between each sample tested, the panellist were allowed a break of 3 minutes. Every test is repeated. The FIZZ (French Bio System) is used to collect and calculate data and the resutls were transformed to sensory time intensity diagram as shown in FIG. 17.

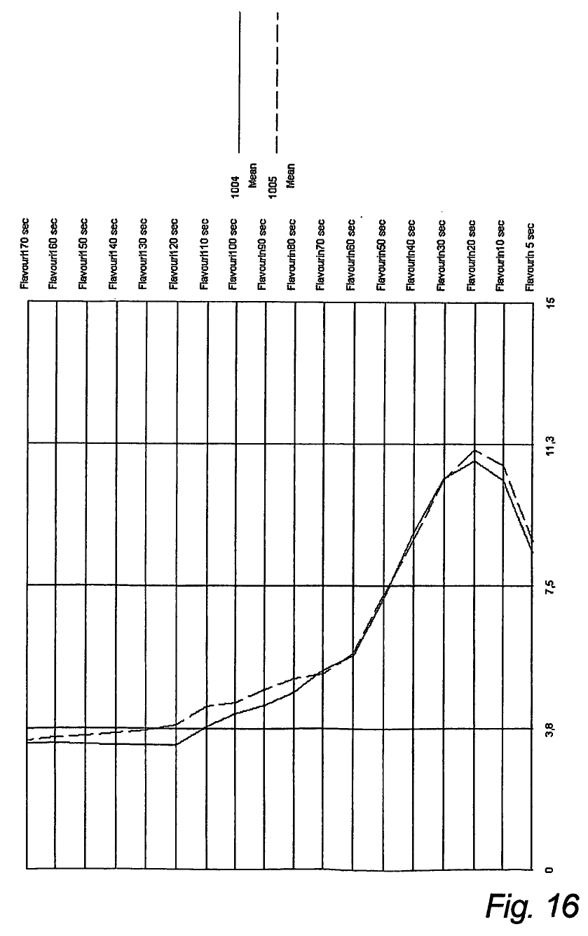

The flavour intensity of strawberry flavoured chewing gum containing elastomer made with 4-arms star shaped initiator 1005 has an higher overall flavours intensity compared with chewing gum formulation containing HMWE elastomer made with a difunctional initiator 1004 (FIG. 16).

1. Degradable chewing gum polymer, comprising a polymer polymerized from
at least one trifunctional or higher functional initiator
at least two different monomers forming the backbone of the polymer and
at least one monomer selected from the group consisting of carbonate monomers.

2. Degradable chewing gum polymer according to claim 1, wherein said at least two different monomers are cyclic.

3. Degradable chewing gum polymer according to claim 1, wherein the at least two different monomers forming the backbone of the polymer comprises at least one backbone monomer and at least one backbone comonomer,

4. Degradable chewing gum polymer according to claim 1, wherein said at least one backbone comonomer imparts disorder in the backbone monomer chain.

5. Degradable chewing gum polymer according to any of the claims 1-4, wherein the at least one backbone comonomer is effective to introduce amorphous regions in the backbone monomer chain.

6. Degradable chewing gum polymer according to claim 1,
wherein the at least two different monomers forming the backbone of the polymer are selected from the group consisting of lactone monomers.

7. Degradable chewing gum polymer according to claim 6, wherein the lactone monomers are chosen from the group consisting of ε-caprolactone, δ-valerolactone, γ-butyrolactone, β-propiolactone, and mixtures thereof, and wherein the lactone monomers are optionally substituted with one or more alkyl or aryl substituents at any non-carbonyl carbon atoms along the ring, including compounds in which two substituents are contained on the same carbon atom and mixtures thereof.

8. Degradable chewing gum polymer according to claim 3, wherein the at least one backbone monomer comprises ε-caprolactone.

9. Degradable chewing gum polymer according to claim 3, wherein the at least one backbone monomer has a Tg below −40° C.

10. Degradable chewing gum polymer according to claim 3, wherein the at least one backbone comonomer comprises δ-valerolactone.

11. Degradable chewing gum polymer according to claim 1, wherein said degradable polymer is polymerized by metal catalyzed ring-opening.

12. Degradable chewing gum polymer according to claim 1, wherein the at least one monomer is selected from the group consisting of cyclic carbonate monomers.

13. Degradable chewing gum polymer according to claim 1, wherein the at least one monomer selected from the group consisting of trimethylene carbonate, 5-alkyl-1,3-dioxan-2-one, 5,5-dialkyl-1,3-dioxan-2-one, or 5-alkyl-5-alkyloxycarbonyl-1,3-dioxan-2-one, ethylene carbonate, 3-ethyl-3-hydroxymethyl trimethylene carbonate, propylene carbonate, trimethylene carbonate, trimethylolpropane monocarbonate, 4, 6dimethyl-1,3-propylene carbonate, 2,2-dimethyl trimethylene carbonate, 1,3-dioxepan-2-one and mixtures thereof.

14. Degradable chewing gum polymer according to claim 1, wherein the at least one monomer selected from the group consisting of carbonate monomers provides a means for introducing additional branching, crosslinking, or a combination thereof to the elastomeric polymer during ring-opening polymerization.

15. Degradable chewing gum polymer according to claim 1, wherein said at least one trifunctional or higher functional initiator comprises a polyol.

16. Degradable chewing gum polymer according to claim 1, wherein the initiator is selected from the group of glycerol, trimethylolpropane, pentaerythritol, dipentaerythritol, ethoxylated or propoxylated polyamines, molecules with multiple hydroxyl or other reactive groups, and mixtures thereof.

17. Degradable chewing gum polymer according to claim 1, wherein the degradable chewing gum polymer is polymerized from:
about 20 to 80 wt % of the at least one backbone monomer,
about 19.5 to 79.5 wt % of the at least one backbone comonomer,
about 0.5 to 25 wt % of the at least one monomer selected from the group of carbonate monomers.

18. Degradable chewing gum polymer according to claim 17, wherein the degradable chewing gum polymer is polymerized from:
about 0.01 to 1.0 wt % of the at least one initiator.

19. Degradable chewing gum polymer according to claim 1, wherein the chewing gum properties of the polymer are adjusted by selection of a suitable functional number of the multifunctional initiator.

20. Degradable chewing gum polymer according to claim 1, wherein the rheological properties of the degradable polymer is controlled by adjusting the functional number of initiator.

21-22. (canceled)

23. Degradable chewing gum polymer according to claim 6, wherein the molecular weight of lactone monomers are within the range of 50-16000 g/mol.

24. Degradable chewing gum polymer according to claim 1, wherein the molecular weight of carbonate monomers are within the range of 50-15000 g/mol.

25. Chewing gum comprising the degradable polymer according to claim 1; and chewing gum ingredients.

26. Chewing gum according to claim 25, wherein said chewing gum ingredients comprise flavoring agents.

27. Chewing gum according to claim 26, wherein said flavoring agents comprises natural and synthetic flavorings in the form of natural vegetable components, essential oils, essences, extracts, powders, including acids or other substances capable of affecting the taste profile

28. Chewing gum according to claim 26, wherein said chewing gum comprises flavoring agents in an amount of 0.01 to about 30 wt %, said percentage being based on the total weight of the chewing gum.

29. Chewing gum according to claim 26, wherein said chewing gum comprises flavoring agents in an amount of 0.2 to about 4 wt %, said percentage being based on the total weight of the chewing gum

30. Chewing gum according to claim 26, wherein said flavoring agent comprises water soluble ingredients.

31. Chewing gum according to claim 30, wherein said water soluble flavoring agent comprises acids.

32. Chewing gum according to claim 26, wherein said flavoring agent comprises water insoluble ingredients.

33. Chewing gum according to claim 25, wherein said chewing gum ingredients comprises sweeteners.

34. Chewing gum according to claim 33, wherein said sweetener comprises bulk sweeteners.

35. Chewing gum according to claim 34, wherein the chewing gum comprises bulk sweeteners in the amount of about 5 to about 95% by weight of the chewing gum.

36. Chewing gum according to claim 33, wherein said sweetener comprises high intensity sweeteners.

37. Chewing gum according to claim 36, wherein the high intensity sweeteners comprises sucralose, aspartame, salts of acesulfame, alitame, saccharin and its salts, cyclamic acid and its salts, glycyrrhizin, dihydrochalcones, thaumatin, monellin, sterioside, alone or in combination.

38. Chewing gum according to claim 36, wherein the chewing gum comprises high intensity sweeteners in an amount of about 0 to about 1% by weight of the chewing gum.

39. Chewing gum according to claim 25, wherein the chewing gum comprises at least one softener.

40. Chewing gum according to claim 39, wherein the at least one softener comprises tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids, -stearic acid, palmitic acid, oleic acid, linoleic acids, waxes, poly glycol esters or mixtures thereof.

41. Chewing gum according to claim 39, wherein the chewing gum comprises softeners in the amount of about 0 to about 18% by weight of the chewing gum.

42. Chewing gum according to claim 25, wherein said chewing gum ingredients comprise active ingredients.

43. Chewing gum according to claim 42, wherein said active ingredients are selected from the group consisting of: Acetaminophen, Acetylsalicylic acid, Buprenorphine, Bromhexin, Celcoxib, Codeine, Diphenhydramin, Diclofenac, Etoricoxib, Ibuprofen, Indometacin, Ketoprofen, Lumiracoxib, Morphine, Naproxen, Oxycodon, Parecoxib, Piroxicam, Rofecoxib, Tenoxicam, Tramadol, Valdecoxib, Calciumcarbonat, Magaldrate, Disulfiram, Bupropion, Nicotine, Azithromycin, Clarithromycin, Clotrimazole, Erythromycin, Tetracycline, Granisetron, Ondansetron, Prometazin, Tropisetron, Brompheniramine, Ceterizin, leco-Ceterizin, Chlorcyclizine, Chlorpheniramin, Chlorpheniramin, Difenhydramine, Doxylamine, Fenofenadin, Guaifenesin, Loratidin, des-Loratidin, Phenyltoloxamine, Promethazin, Pyridamine, Terfenadin, Troxerutin, Methyldopa, Methylphenidate, Benzalcon, Chloride, Benzeth, Chloride, Cetylpyrid, Chloride, Chlorhexidine, Ecabet-sodium, Haloperidol, Allopurinol, Colchinine, Theophylline, Propanolol, Prednisolone, Prednisone, Fluoride, Urea, Miconazole, Actot, Glibenclamide, Glipizide, Metformin, Miglitol, Repaglinide, Rosiglitazone, Apomorfin, Cialis, Sildenafil, Vardenafil, Diphenoxylate, Simethicone, Cimetidine, Famotidine, Ranitidine, Ratinidine, cetrizin, Loratadine, Aspirin, Benzocaine, Dextrometorphan, Ephedrine, Phenylpropanolamine, Pseudoephedrine, Cisapride, Domperidone, Metoclopramide, Acyclovir, Dioctylsulfosucc, Phenolphtalein, Almotriptan, Eletriptan, Ergotamine, Migea, Naratriptan, Rizatriptan, Sumatriptan, Zolmitriptan, Aluminium salts, Calcium salts, Ferro salts, Silver salts, Zinc-salte, Amphotericin B, Chlorhexidine, Miconazole, Triamcinolonacetonid, Melatonine, Phenobarbitol, Caffeine, Benzodiazepiner, Hydroxyzine, Meprobamate, Phenothiazine, Buclizine, Brometazine, Cinnarizine, Cyclizine, Difenhydramine, Dimenhydrinate, Buflomedil, Amphetamine, Caffeine, Ephedrine, Orlistat, Phenylephedrine, Phenylpropanolamin, Pseudoephedrine, Sibutramin, Ketoconazole, Nitroglycerin, Nystatin, Progesterone, Testosterone, Vitamin B12, Vitamin C, Vitamin A, Vitamin D, Vitamin E, Pilocarpin, Aluminiumaminoacetat, Cimetidine, Esomeprazole, Famotidine, Lansoprazole, Magnesiumoxide, Nizatide and/or Ratinidine or derivates and mixtures thereof.

44. Chewing gum according to claim 25, wherein the chewing gum is substantially free of non-biodegradable polymers.

45. Chewing gum according to claim 25, wherein the chewing gum comprises filler.

46. Chewing gum according to claim 45, wherein the chewing gum comprises filler in an amount of about 0 to about 50% by weight of the chewing gum.

47. Chewing gum according to claim 25, wherein the chewing gum comprises at least one coloring agent.

48. Chewing gum according to claim 25, the chewing gum is coated with an outer coating.

49. Chewing gum according to claim 48, wherein the outer coating is a hard coating.

50. Chewing gum according to claim 49, wherein the hard coating is a coating selected from the group consisting of a sugar coatings, a sugarless coating, and a combination thereof.

51. Chewing gum according to claim 49, wherein the hard coating comprises 50 to 100% by weight of a polyol selected from the group consisting of sorbitol, maltitol, mannitol, xylitol, erythritol, lactitol and isomalt.

52. Chewing gum according to claim 51, wherein the outer coating is an edible film comprising at least one component selected from the group consisting of an edible film-forming agent and a wax.

53. Chewing gum according to claim 52, wherein the film-forming agent is selected from the group consisting of a cellulose derivative, a modified starch, a dextrin, gelatine, shellac, gum arabic, zein, a vegetable gum, a synthetic polymer and any combination thereof.

54. Chewing gum according to claim 48, wherein the outer coating comprises at least one additive component selected from the group consisting of a binding agent, a moisture absorbing component, a film forming agent, a dispersing agent, an antisticking component, a bulking agent, a flavouring agent, a coloring agent, a pharmaceutically or cosmetically active component, a lipid component, a wax component, a sugar, an acid and an agent capable of accelerating the after-chewing degradation of the degradable polymer.

55. Chewing gum according to claim 48, wherein the outer coating is a soft coating.

56. Chewing gum according to claim 55, wherein the soft coating comprises a sugar free coating agent.

57. Chewing gum according to claim 25, wherein said chewing gum comprises conventional chewing gum polymers or resins.

58. Chewing gum according to claim 25, wherein the at least one biodegradable polymer comprises at least 5% of the chewing gum polymers.

59. Chewing gum according to claim 25, wherein all the biodegradable polymers comprised in the chewing gum comprises at least 25%, of the chewing gum polymers.

60. Chewing gum according to claim 25, wherein all the biodegradable polymers comprised in the chewing gum comprises at least 80%, of the chewing gum polymers.

61. Chewing gum according to claim 25, wherein said chewing gum comprises
said at least one biodegradable polyester copolymer forming a plasticizer of the chewing gum and
at least one non-biodegradable conventional elastomer.

62. Chewing gum according to claim 25, wherein said chewing gum comprises
said at least one biodegradable polyester copolymer forming an elastomer of the chewing gum and
at least one non-biodegradable conventional natural or synthetic resin.

63. Chewing gum according to claim 25, wherein said chewing gum comprises
at least one biodegradable elastomer in the amount of about 0.5 to about 70% wt of the chewing gum,
at least one biodegradable plasticizer in the amount of about 0.5 to about 70% wt of the chewing gum and
at least one chewing gum ingredient chosen from the group consisting of softeners, sweeteners, flavoring agents, active ingredients and fillers in the amount of about 2 to about 80% wt of the chewing gum.

64. Gum base comprising at least one degradable chewing gum polymer according to claim 1.
